(19) United States
(12) Patent Application Publication
(10) Pub. No.: US 2007/0280382 A1
(43) Pub. Date: Dec. 6, 2007

(54) METHODS AND SYSTEMS FOR CORRELATION BASED ON PHASE QUANTIZATION

(75) Inventors: Anuj Batra, Dallas, TX (US); Srinath Hosur, Plano, TX (US); Doron Burshtein, Ramat-Efal (IL)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/750,882

(22) Filed: May 18, 2007

Related U.S. Application Data
(60) Provisional application No. 60/747,552, filed on May 18, 2006.

(51) Int. Cl. H04L 27/06

(52) U.S. Cl. 375/343

(57) ABSTRACT

In at least some embodiments, an electronic device is provided. The electronic device having a receiver that determines multi-bit quantization of phase information for a first signal and a second signal and correlates the first and second signals based on the quantized phase information. In at least some embodiments, a receiver is provided. The receiver has an analog-to-digital converter (ADC) and a filter. The receiver also has a correlator that receives a first signal from the filter. The correlator computes multi-bit quantization of phase information for the first signal and a second signal and determines a correlation between the first and second signals based on the quantized phase information. In at least some embodiments, a method is provided. The method comprises providing a multi-bit quantization of phase information for a first signal and a second signal. The method further comprises correlating the first and second signals based on the quantized phase information.

### CROSS-REFERENCE TO RELATED APPLICATIONS

This application is a non-provisional application claiming priority to U.S. patent application Ser. No. 60/747,552, entitled “Low-Complexity Higher Precision Correlators”, filed on May 18, 2006. The above-referenced application is incorporated herein by reference.

### FIELD OF THE INVENTION

The present disclosure is directed to communication systems, and more particularly, but not by way of limitation, to communication systems that rely on data correlation for packet detection, boundary detection or Fast-Fourier Transform (FFT) placement.

### BACKGROUND

In order for electronic devices to communicate, a wireless or wired protocol (i.e., standard) defines hardware and software parameters that enable the devices to send, receive, and interpret data. There are various examples of communication protocols and the Federal Communications Commission (FCC) has allocated different frequency ranges (spectrums) for these different wireless protocols. The 802.11(a) protocol provided by the Institute of Electrical and Electronics Engineers (IEEE) specifies operating in a frequency range from 4.9-5.85 GHz (part of the Unlicensed National Information Infrastructure (U-NII) band). The 802.11(g) and 802.11(n) protocols have also been developed. The Worldwide Interoperability of Microwave Access (WiMAX) protocol specifies operating in frequency range from 3.3-3.8 GHz and from 5.4-5.825 GHz. More recently, the Ultra Wideband (UWB) protocol specifies operating in a frequency range from 3.1-10.6 GHz. The UWB protocol is based on Multi-band Orthogonal Frequency Division Multiplexing (OFDM) and is defined by the ECMA-368 specification provided by the WiMedia Alliance. Additional protocols such as Long Term Evolution (LTE) protocols are also being developed.

One component common to many communication systems is referred to as a “data correlator”. A data correlator compares two signals and determines how similar the signals are to each other. If one of the signals is known and the other unknown, the data correlator identifies the extent to which the unknown signal matches the known signal. The output of a correlator can be written as

$$y ( k ) = {\sum }_{n = 0}^{N - 1} c ( n ) r ( k - n ) ,$$

where r(k) is a received signal, c(k) is a known or discoverable sequence and y(k) is the output sequence.

There are different ways to perform data correlation. In full-precision correlation, multipliers are implemented, which increases the complexity (in terms of logic gates) of a correlator. One simplification is referred to as sign-sign correlation. In sign-sign correlation, the received signal r(k) can be simplified as rₛᵢₘₚ(k)=sign(r_{REAL}(k))+jsign(r_{IMAG}(k)), which represents the sign bit of the real portion of the received signal plus j times the sign bit of the imaginary portion of the received signal. The known sequence c(k) can also be simplified as cₛᵢₘₚ(k)=sign(c_{REAL}(k))+jsign(c_{IMAG}(k)), which represents the sign bit of the real portion of the known sequence plus j times the sign bit of the imaginary portion of the known sequence. The effect of these simplifications is to eliminate multipliers from the correlator (i.e., any complex number times ±1 or ±j can be computed using only additions). In summary, a sign-sign correlator has fewer logic gates compared to a full-precision correlator, but performance is reduced. Methods and systems that improve correlation without the complexity of full-precision correlation are desirable, especially when signal-to-noise ratio (SNR) is low.

### SUMMARY

In at least some embodiments, an electronic device comprises a receiver that determines multi-bit quantization of phase information for a first signal and a second signal. The receiver correlates the first and second signals based on the quantized phase information.

In at least some embodiments, a receiver comprises an analog-to-digital converter (ADC) and a filter. The receiver further comprises a correlator that receives a first signal from the filter. The correlator computes multi-bit quantization of phase information for the first signal and a second signal and determines a correlation between the first and second signals based on the quantized phase information.

In at least some embodiments, a method comprises providing a multi-bit quantization of phase information for a first signal and a second signal. The method further comprises correlating the first and second signals based on the quantized phase information.

### BRIEF DESCRIPTION OF THE DRAWINGS

For a detailed description of various embodiments of the invention, reference will now be made to the accompanying drawings in which:

FIG. 1 illustrates an electronic device in accordance with embodiments of the disclosure;

FIG. 2 illustrates a correlator operation in accordance with embodiments of the disclosure;

FIG. 3 illustrates a phase quantization in accordance with embodiments of the disclosure;

FIG. 4 illustrates a receiver in accordance with embodiments of the disclosure; and

FIG. 5 illustrates a method in accordance with embodiments of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the disclosure provide methods and systems for data correlation. In at least some embodiments, data correlation involves quantizing phase information of the signals being correlated. For example, the phase information for each point of a signal can be quantized as a two-bit, three-bit or four-bit value. Multi-bit phase quantization enables signal correlation without relying on multipliers, yet performance approximating that of a full-precision correlator can be achieved. In some embodiments, correlation of a first and second signal involves a delay line.

In at least some embodiments, correlation involves projecting a received signal onto the unit circle to exploit phase information rather than magnitude information. In other wrods, correlation of a first and second signal can be performed in the phase-domain instead of the Cartesian domain. Mathematically, the received signal can be expressed as rₚᵣₒⱼ(k)=exp(j∠r(k)). The complexity of the correlation algorithm can be limited by quantizing the angle of r(k) to a finite number of values around the unit circle. In some embodiments, the quantized angles on the unit circle can be uniformly and equally spaced. For example, if the angle of r(k) is quantized to two-bits or equivalently to four angles around the unit (e.g., 45°, 135°, 225°, 315°), correlation can be simplified to rely on the sign of a real portion of the received signal plus j times the sign of an imaginary portion of the received signal. By increasing the number of points around the unit circle (i.e., increasing the phase quantization), a higher precision representation of the received signal can be achieved. Although other embodiments are possible, 3-bits (8 angles) or 4-bits (16 angles) of phase resolution can be implemented in correlation algorithms herein. The angles of the received signals can be determined, for example, using the Cordic algorithm, which is well-known and has an efficient implementation in hardware.

The reduction in complexity for a correlator (e.g., eliminating multipliers) can be achieved by also projecting a known or discoverable sequence c(k) onto the unit circle as c(k)=exp(∠c(k)). As an example, c(k) can be derived from a preamble having certain repetitive structures. In such case, c(k) is not known apriori to the receiver, but is simply a delayed version of the received signal. Accordingly, correlation can be between two received signals, where one of the signals is delayed. Another example of c(k) is related to DTV (Digital Television), where a symbol prefix is the same as the latter portion of the symbol. Thus, correlation can be between the prefix portion of a received signal and a corresponding portion at the end of the symbol. The correlation can be used to determine where each symbol starts.

The multiplication term in the correlation equation can be represented as c(n)r(k−n)=exp(∠c(n))exp(∠r(k−n))=exp(∠c(n)+∠r(k−n)), which can be completed based on an addition (∠c(n)+∠r(k−n)) and a look-up table operation to determine the exponential value of the phases. In alternative embodiments, an exponential value of the phases can be estimated using, for example, a Taylor series approximation. The output of the correlator is then a set of additions. By selectively increasing phase quantization for r(k) and c(k), the precision of correlation can be improved even though multipliers are eliminated.

One advantage of phase quantization is that the phases, after addition, will again be on the unit circle. Also, the number of angles, after addition, remain equal to the number of angles in the original sequences. Thus, any delay lines used to hold the correlation values can have the same precision as the original sequences. As an example, any multiplication of the points exp(jnπ/4), where n=0:7, give the points exp(jnπ/4), where n=0:7. Advantageously, the result can still be represented by 3-bits.

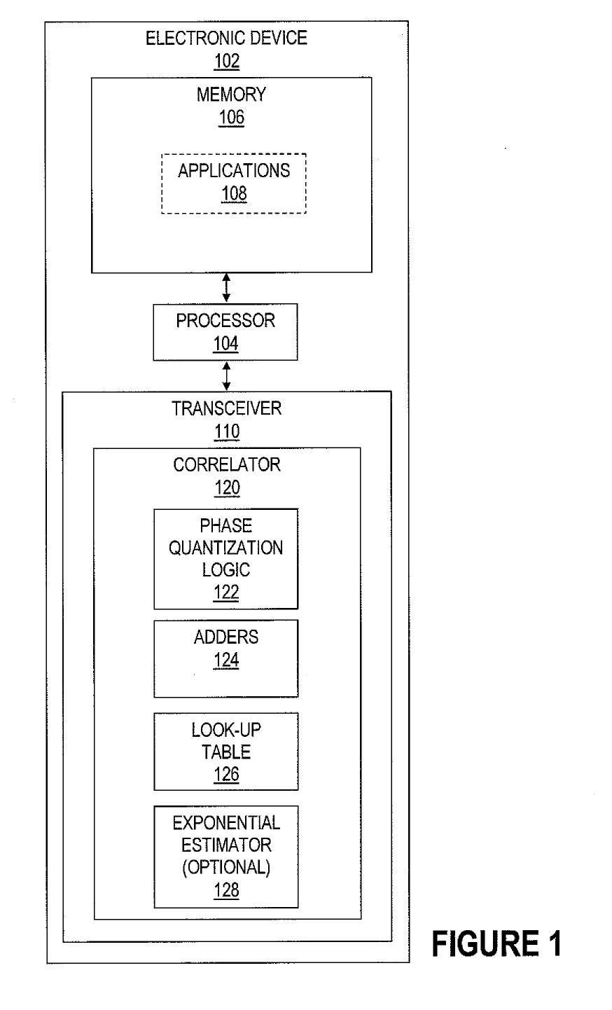

FIG. 1 illustrates an electronic device 102 in accordance with embodiments of the disclosure. Electronic devices such as the device 102 communicate wirelessly (or via a wired connection) using a variety of techniques to prepare, send, receive, and recover data. For example, data preparation techniques may include data scrambling, error correction coding, interleaving, data packet formatting, and/or other techniques. The data to be transmitted is converted into blocks of data (i.e., bits) transmitted as information symbols. Each information symbol is associated with a constellation of complex amplitudes.

If data communication is wireless, the electronic device 102 may employ one or more antennas to “pick up” wireless signals, after which data is recovered by sampling the received signal and decoding each information symbol. To recover data, the electronic device 102 may implement techniques such as signal amplification, digitization, sample rate conversion, data correlation, equalization, demodulation, de-interleaving, de-coding, and/or de-scrambling. In at least some embodiments, data correlation enables the electronic device 102 to perform functions such as packet detection, boundary detection or Fast-Fourier Transform (FFT) placement.

The electronic device 102 may represent any of a variety of devices such as a server, a desktop computer, a laptop computer, a cellular phone, a Personal Digital Assistant (PDA), a smart phone or other electronic devices. In various embodiments, the electronic device 102 receives communications based on an 802.11(a), (g), or (n) protocol, a Worldwide Interoperability of Microwave Access (WiMAX) protocol, an Ultra Wideband (UWB) protocol or some other communication protocol now known or later developed.

As shown, the electronic device 102 comprises a processor 104 coupled to a memory 106 and a transceiver 110. The memory 106 stores applications 108 for execution by the processor 104. The applications 108 could comprise any known or future application useful for individuals or organizations. As an example, such applications 108 could be categorized as operating systems, device drivers, databases, presentation tools, emailers, file browsers, firewalls, instant messaging, finance tools, games, word processors or other categories. Regardless of the exact nature of the applications 108, at least some of the applications 108 may rely on signals received via the transceiver 110. To improve proper detection and processing of received signals, the transceiver 110 employs a correlator 120, which enables functions such as packet detection, boundary detection or FFT placement. The correlator 120 comprises hardware, firmware, software, or a combination thereof.

As shown, the correlator 120 of FIG. 1 comprises phase quantization logic 122, adders 124 and a look-up table (LUT) 126. Optionally, the correlator 120 comprises an exponential estimator 128 that estimates an exponential operation (e.g., using a Taylor series). In at least some embodiments, the phase quantization logic 122 quantizes the phase information of two signals to be correlated. The phase quantization may be 2-bits, 3-bits, 4-bits, or more, for each point of the two signals. As an example, the two signals may correspond to a received signal (e.g., r(k)) and a known or discoverable sequence (e.g., c(k)). By increasing the number of bits used for phase quantization, the performance of the correlator 120 can be increased.

The adders 124 perform add functions as part of the correlation process. In at least some embodiments, the adders 124 add the phases for each point of a first signal to the phases for each point of a second signal. The LUT 126 relates a plurality of multi-bit values (e.g., 000 to 111) with different quantized phases around a unit circle. Additionally or alternatively, the LUT 126 relates a plurality of multi-bit values to an exponentiation of different quantized phases. In alternative embodiments, an exponential estimator 128 can be employed instead of an LUT to determine an exponentiation of quantized phases. In either case, the output of the correlator 120 can be simplified to be the summation of exp(∠c(n)+∠r(k−n)), where n ranges from 0 to N−1. By choosing an appropriate multi-bit phase quantization, a high-performance correlator can be achieved without multipliers.

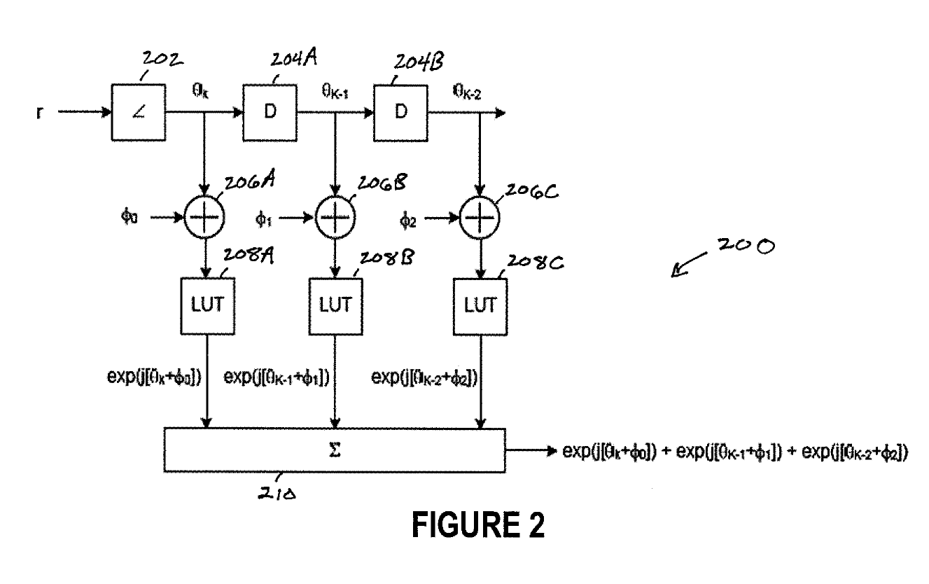

FIG. 2 illustrates a correlator operation 200 in accordance with embodiments of the disclosure. As shown, the correlator operation 200 relies on phase quantization logic 202 that quantizes a phase (θ_{K}, θ_{K-1}, θ_{K-2} and so on) for each point of a received signal r(k). The delay (D) blocks 204A, 204B and so on correspond to sample delay blocks that are used during correlation. As shown, the quantized phases of the received signal are added to quantized phases (φ₀, φ₁, φ₂ and so on) of a sequence c(k) by a plurality of adders 206A, 206B, 206C and so on.

As an example of the adder function, consider a phase quantization that corresponds to eight points on the unit circle. In such case, the phase of each point for r(k) could be quantized to one of eight points: exp(j*0), exp(j*2π/8), exp(j*2*2π/8), . . . exp(j*7*2π/8). Also, the phase of each point for c(k) could be quantized to one of eight points: exp(j*0), exp(j*2π/8), exp(j*2*2π/8), . . . exp(j*7*2π/8). In the eight point example, these quantized phases can be represented for r(k) and c(k) using the binary numbers for 0, 1, 2, 3, 4, 5, 6, and 7. Since the correlator operation can be simplified so that the phases are inside an exponentiation (i.e., r(k)*c(k)=exp(j*(phase of r(k)+phase of c(k)))), the phases add together and the result will also be a phase. Some examples of adding phases together include: 0+1=1 or 0+2π/8=2π/8; 0+2=2; 0+3=3; 0+4=4; 0+5=5; 0+6=6; 0+7=7; 1+1=2 or 2π/8+2π/8=2*2π/8; 1+2=3 or 2π/8+2*2π/8=3*2π/8; 1+3=4; 1+4=5; 1+6=7; 1+7=8 or 2π/8+7*2π/8=2π=0, since as an angle of 2π is the same as angle 0 after the exponentiation. For each add operation, a modulo function (e.g., modulo 8) is performed so that result of adding two 3-bit numbers is a 3-bit number (i.e., only the last 3 bits of the result are kept). A general extension of this concept can be described as the addition of any two of the 2ˆn phase points around the unit circle, where the phase points represent each of a plurality of quantized phases from 0 to 2π as 0 to 2ˆn−1 using n-bit numbers. The phases are added and the last n-bits of the addition are kept. The angle corresponding to the last n-bits of the addition is the result.

In the correlation operation 200 of FIG. 2, the exponential of each phase combination is determined using LUTs 208A, 208B, 208C and so on. The LUTs 208A, 208B, 208C represent a single LUT or a combination of LUTs. In alternative embodiments, the exponential of each phase combination can be estimated using, for example, a Taylor series estimation. The exponentials of the phase combinations are summed using summation logic 210 as the output of the correlation operation 200. The resulting output determines the extent to which a received signal correlates with a known or discoverable sequence.

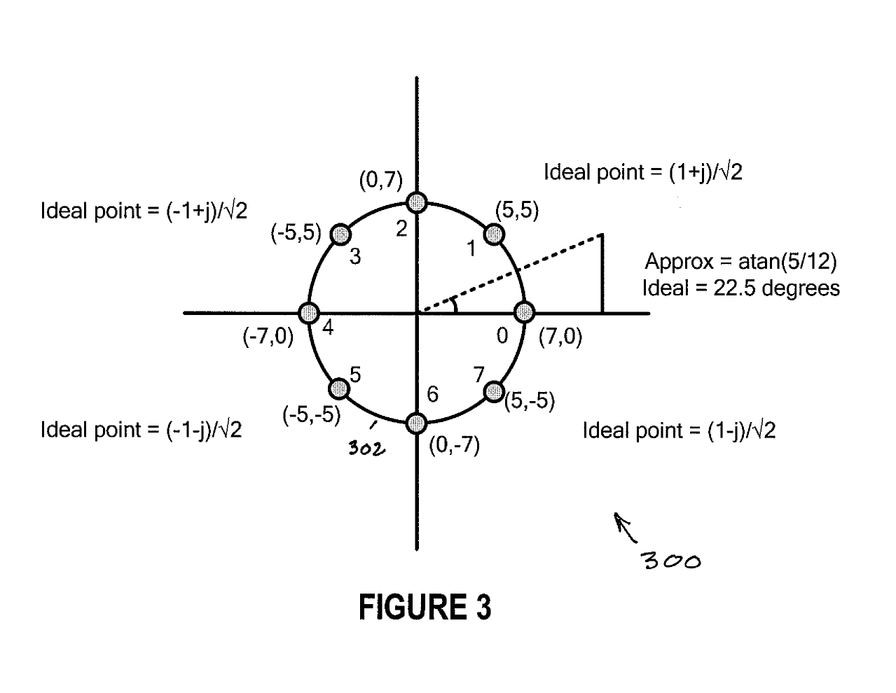

FIG. 3 illustrates a phase quantization 300 in accordance with embodiments of the disclosure. The phase quantization 300 represents 3-bit quantization, where eight angles corresponding to the 3-bit quantization are shown around the unit circle 302. The eight quantized points on the unit circle 302 are described as: (7,0), (5,5), (0,7), (−5,5), (−7,0), (−5,−5), (0,−7) and (5,−5). Any normalization factor can be used in order to make a unit circle and one possibility is to normalize all points by 7. As an example of an alternative embodiment, the quantized points (31,0), (22,22), (0,31), (−22,22), (−31,0), (−22,−22), (0,−31) and (22,−22) could be used.

As previously mentioned, the phase quantization logic 122 of the correlator 120 quantizes the phases for each point of the received signal and a known or discoverable sequence. In other words, the phase quantization logic 122 is able to quantize an arbitrary point (x,y) on the unit circle to one of the eight angles shown in FIG. 3. In alternative embodiments, the arbitrary point is not on the unit circle. In either case, the phase quantization logic 122 may accomplish the task of quantizing the arbitrary point's phase by determining the quadrant of the arbitrary point. Since all four quadrants are symmetric, the quantization task can be narrowed into a single quadrant (e.g., the first quadrant) analysis after the correct quadrant has been determined. Once the single quadrant analysis is complete, the quantized point can be assigned to the correct quadrant.

As an example of a single quadrant analysis, the first quadrant is analyzed herein. In the first quadrant of FIG. 3, there are 3 points: (7,0), (5,5) and (0,7). Since these three points are symmetric around (5,5), determining that the real part is greater than the imaginary part (i.e., x>y) would indicate that the arbitrary point (x,y) is between (7,0) and (5,5). Alternatively, determining that the real part is less than the imaginary part (y>x) would indicate that the arbitrary point (x,y) is between (5,5) and (0,7). If y>x, the task of quantizing the arbitrary point can be transformed into resolving a point between (7,0) and (5,5) by swapping the x and y values. Once the quantized point has been found between (7,0) and (5,5), the previous transformation can be undone by swapping the x and y values so that the quantized point will be in the set (5,5) and (0,7).

To quantize the arbitrary point between (7,0) and (5,5), a test angle between these points (22.5 degrees is ideal) is selected. The ideal angle can be approximated as atan(5/12)=22.6 degrees. Alternatively, the ideal angle can be approximated as atan(408/985), atan (41/99) or atan (12/29).

The following hypothesis test can be used to determine whether the point (x,y) is closer to (7,0) or closer to (5,5). If atan(y/x)<atan(5/12), select (7,0) as the quantized point. If atan(y/x)>atan(5/12), select (5,5) as the quantized point. If there is equality, then either point can be selected. The hypothesis test can be simplified by undoing the atan on both sides, because atan is monotonic in the first quadrant. In such case, the simplified hypothesis test is: if y/x<5/12, select (7,0) as the quantized point; if y/x>5/12, select (5,5) as the quantized point. The test can be further simplified to eliminate the divides as follows: if 5x−12y>0, select (7,0) as the quantized point; if 5x−12y<0, select (5,5) as the quantized point. As in known in the art, these operations could rely on shifters and adders rather than multipliers (e.g., 5x=4x+x, which can implement by a shifting operation to obtain the 4x and the final result just needs an adder). The same technique can be used for 12y.

In alternative embodiments, 4-bit phase quantization can be used rather than 3-bit phase quantization. In such case, the 16 quantized points could be: (13,0), (12,5), (9,9), (5,12), (0,13), (−5,12), (−9,9) (−12,5), (−13,0), (−12,−5), (−9,−9), (−5,−12), (0,−13), (5,−12), (9,−9), and (12,−5). Alternatively, the 16 quantized points could be (157,0), (145,60), (111,111), (60,145), (0,157), (−60,145), (−111,111) (−145,60), (−157,0), (−145,−60), (−111,−111), (−60,−145), (0,−157), (60,−145), (111,−111), and (145 −60) Possible test angles for quantizing an arbitrary point in the first quadrant when 16 quantized points are used include, but are not limited to, atan (256/1287), atan (32/161) and atan (1/5). The same hypothesis test described for the 3-bit case can be extended to the 4-bit case, except that two comparisons are performed in the first quadrant to determine whether an arbitrary point (x,y) is closer to (13,0) or (12,5) or (9,9). The appropriate test angle between (13,0) and (12,5) is 11.25 degrees and the appropriate test angle between (12,5) and (9,9) is 22.5 degrees.

In alternative embodiments, 2-bit phase quantization can be used. In such case, the 4 quantized points could be: (5,5) (−5,5) (5,−5), and (−5,−5). Alternatively, the 4 quantized point could be: (22,22), (22,−22), (−22,22), and (−22,−22). Possible test angles for quantizing an arbitrary point in the 2-bit case include atan(0/1), where 0 degrees is ideal. In the case of 2-bit quantization, just determining which quadrant the arbitrary point lies in is sufficient to assign the arbitrary point to one of the quantized points.

As previously described, an LUT 126 can be used to relate a plurality of multi-bit values to a quantized phase. Table 1 shows an LUT relationship in the case of 3-bit (e.g., 0 to 7) phase quantization.

TABLE 1

| Angle number or Quantized | |
|---|---|
| Phase Number (LUT input) | |
| (red points in figure) | LUT output |
| 0 | (7, 0) = 7 |
| 1 | (5, 5) = 5 + 5j |
| 2 | (0, 7) = 7j |
| 3 | (−5, 5) = −5 + 5j |
| 4 | (−7, 0) = −7 |
| 5 | (−5, −5) = −5 − 5j |
| 6 | (0, −7) = −7j |
| 7 | (5, −5) = 5 − 5j |

As show in Table 1, each angle number or quantized phase number (0 to 7) corresponds to eight possible phases. The addition of the angles is equivalent to adding the angle numbers or quantized phase numbers modulo 2ˆ3=8. Similar LUTs can be used for 2-bit and 4-bit phase quantization. Also, LUTs can relate a quantized phase with an exponentiation of the quantized phase for use by the correlator 120.

Another description of quantizing phases for the adder function of the correlator 120 can be described as follows. The inputs to the correlator, r(k) and c(k), are quantized to the closest of the eight points:

$$exp ( j 0 ) , exp ( j \frac{2 π}{8} ) , exp ( j 2 \frac{2 π}{8} ) , ⋯ exp ( j7 \frac{2 π}{8} ) .$$

In some embodiments, the quantization is accomplished by computing

$${r}_{a} ( k ) = {tan}^{- 1} ( \frac{imag ( r ( k ) )}{real ( r ( k ) )} ) and {c}_{a} ( k ) = {tan}^{- 1} ( \frac{imag ( c ( k ) )}{real ( c ( k ) )} ) .$$

These angles are then quantized to the closest multiple of 2π/8 (i.e., r_{aq}(k) and c_{aq}(k) can be described as

$${r}_{aq} ( k ) = p \frac{2 π}{8} and {c}_{aq} ( k ) = m \frac{2 π}{8} ) .$$

An exponentiation is then performed to determine r_{q}(k)=exp(jr_{aq}(k)) and c_{q}(k)=exp(jc_{aq}(k)). In at least some embodiments, the exponentiation is performed using an LUT.

For correlation, the multiplication mul(k)=r_{q}(k)c_{q}(k) needs to be performed. The multiplication is avoided by relying on the phase domain information, exponentiation, and adders. In other words, mul(k)=exp(j(r_{aq}(k)+c_{aq}(k))). Since

$${r}_{aq} ( k ) = p \frac{2 π}{8} and {c}_{aq} ( k ) = m \frac{2 π}{8}$$

are multiples of 2π/8 and exp(j(2πk+θ))=exp(jθ), the mul(k) result will remain at one of the quantized points. Thus,

$${r}_{aq} ( k ) + {c}_{aq} ( k ) = ( p + m ) \frac{2 π}{8} = ( 8 k + mod ( p + m , 8 ) ) \frac{2 π}{8} ≡ mod ( p + m , 8 ) \frac{2 π}{8} .$$

Since the 2π/8 multiple can be taken care of during the exponentiation, r_{aq}(k) and c_{aq}(k) can be represented by p and m respectively. As an example, p and m could be three-bit numbers that range from 0 to 7.

In at least some embodiments, the multiplication mul(k)=r_{q}(k)c_{q}(k) for correlation can be performed by obtaining p and m, the closest multiples of

$$\frac{2 π}{8}$$

to the phases of r(k) and c(k). Then sₐ(n)=mod(p+m,8) is easily computed by adding the three-bit numbers p and q and retaining the three LSB's of the result (in the case where there are 8 quantized points). Finally, mul(n)=exp(jsₐ(n)) is computed where the exponentiation can be done using an LUT. Alternatively, an exponentiation estimate can be performed.

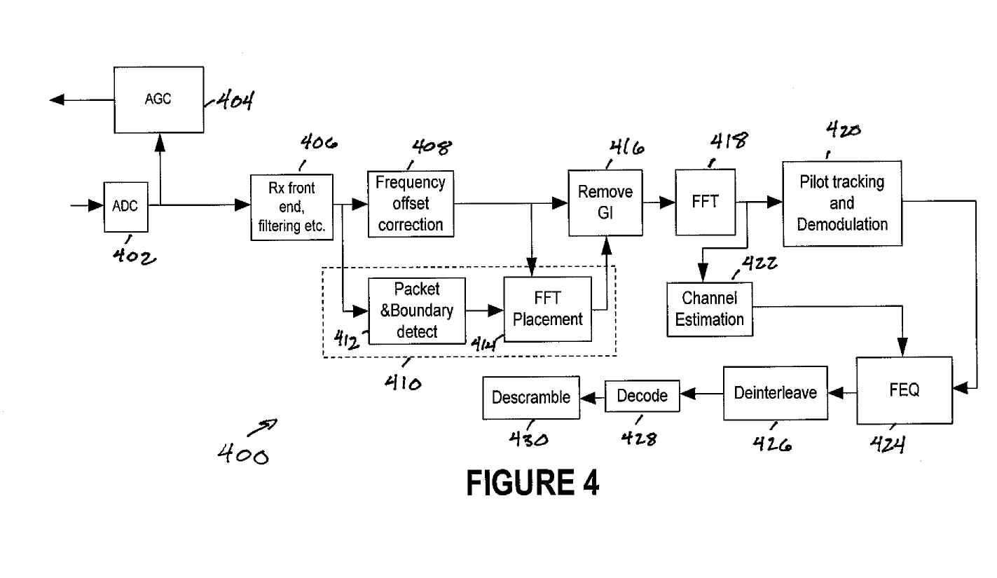

FIG. 4 illustrates a receiver 400 in accordance with embodiments of the disclosure. The receiver 400 can be implemented, for example, by the transceiver 110 described previously for the electronic device 102. As shown in FIG. 4, the receiver 400 comprises an analog-to-digital converter (ADC) block 402 that digitizes an analog signal. The output of the ADC block 402 is provided to an automatic gain control (AGC) block 404 that selectively amplifies a received signal. The output of the ADC block 402 is also provided to a filtering block 406 that filters the received signal. The filtered signal is then input to a correlator 410.

In at least some embodiments, the correlator 410 comprises a packet and boundary detection block 412 and an FFT placement block 414. The correlator 410 quantizes phase information from the filtered signal and a known or discoverable sequence and correlates the received signal with the sequence based on quantized phase information. The correlator 410 may represent the correlator 120 of FIG. 1 and performs the correlation operations described herein based on multi-bit phase quantization, adders, LUTs, and/or exponentiation estimates.

The frequency offset correction block 408 receives the output of the filtering block 406 and corrects frequency offset. The remove guard interval (GI) block 416 strips the samples of the cyclic prefix (i.e., the inverse operation of a cyclic prefix addition). The remove GI block 416 determinates which samples to strip and which samples to present to the FFT block 418 based on information received from the FFT placement block 414. The FFT block 418 performs an FFT over N samples (i.e., the inverse operation of an IFFT). The pilot and derotation block 420 tracks the phase changes due to residual frequency errors using pilots (known data) and derotates the data using the tracked phase.

The frequency equalizer (FEQ) and demodulation block 424 undoes the effects (phase/gain distortions) of the channel between a transmitter and the receiver 400. At a transmitter, the data bits after coding and interleaving are mapped onto PSK/QAM symbols. Accordingly, the FEQ and demodulation block 424 may undo the PSK/QAM operation. If a transmitter interleaves the bits of a signal (an interleaving operation usually pushes the bits that are close together apart), the de-interleaver block 426 undoes such interleave operations. For example, if two bits that are close together are faded deeply (i.e., the bits have a small magnitude after going through the wireless channel), the bits are pushed apart by the de-interleaver block 426, which improves system performance.

The decoder block 428 recovers information bits of the received signal. These information bits may have been encoded by an encoder at a transmitter. The decoder block 428 provides controlled redundancy, whereby if some bits are in error at the receiver 400 due to the channel and noise effects, the bits can be recovered. The descrambler block 430 undoes a scrambling operation that is performed prior to encoding. The scrambling operation avoids patterns of ones and zeros that could cause peak to average power ratios when transmitting data.

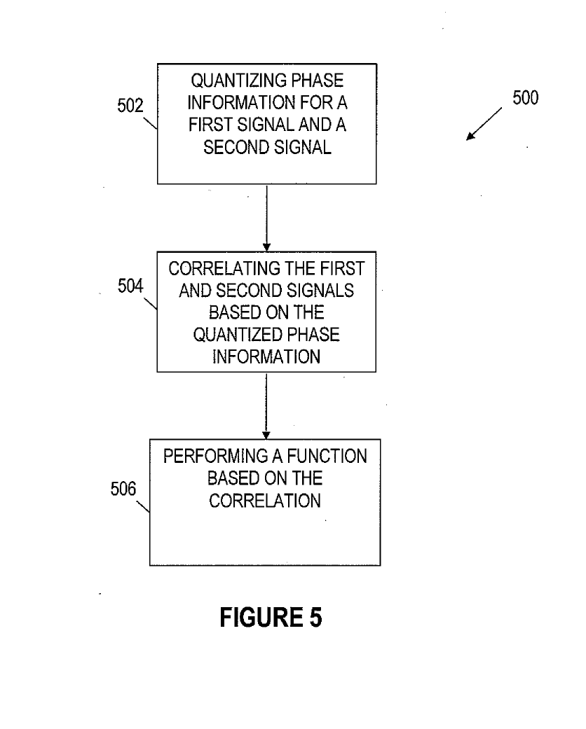

FIG. 5 illustrates a method 500 in accordance with embodiments of the disclosure. As shown, the method 500 comprises quantizing phase information for a first signal and a second signal (block 502). In at least some embodiments, multi-bit quantization is performed. The method 500 further comprises correlating the first and second signals based on the quantized phase information (block 504). At block 506, a function is performed based on the correlation. For example, the function may be packet detection, boundary detection or FFT placement. The method 500 may further comprise various steps for determining multi-bit quantized phase information such as those described herein. Also, the method 500 may comprise various steps for correlating the first and second signals based on the quantized phase information. As described herein, correlating could involve add operations, LUT operations, exponential estimations, summations or other functions.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. An electronic device, comprising:
a receiver that determines a multi-bit quantization of phase information for a first signal and a second signal and correlates the first and second signals based on the quantized phase information.

2. The electronic device of claim 1 wherein receiver correlates the first and second signals through a delay line.

3. The electronic device of claim 1 wherein the receiver correlates the first and second signals in the phase-domain instead of the Cartesian domain.

4. The electronic device of claim 1 wherein the receiver comprises logic that determines a quadrant for each point of the first and second signals.

5. The electronic device of claim 1 wherein the receiver comprises logic that compares a real part and an imaginary part of each point of the first and second signals.

6. The electronic device of claim 5 wherein the logic quantizes phase information for each point of the first and second signals based on the comparison.

7. The electronic device of claim 1 wherein the receiver comprises logic that quantizes phase information of the first and second signals based on at least one test angle.

8. The electronic device of claim 1 wherein the receiver comprises a look-up table (LUT) that relates each of a plurality of multi-bit values to a point around a unit circle.

9. The electronic device of claim 1 wherein the receiver comprises a look-up table (LUT) that relates each of a plurality of multi-bit values to an exponentiation of a point around a unit circle.

10. The electronic device of claim 1 wherein the receiver comprises logic that approximates an exponentiation for each of a plurality of quantized phases.

11. A receiver, comprising:
an analog-to-digital converter (ADC);
a filter; and
a correlator that receives a first signal from the filter, wherein the correlator computes multi-bit quantization of phase information for the first signal and a second signal and determines a correlation between the first and second signals based on the quantized phase information.

12. The receiver of claim 11 wherein the correlator comprises logic that performs a modulo N addition of quantized phase information for the first and second signals, where N is the number of quantized points around a unit circle or non-unit circle.

13. The receiver of claim 11 wherein the correlator performs a function selected from the group consisting of packet detection, boundary detection, and Fast Fourier Transform (FFT) placement.

14. The receiver of claim 11 wherein the multi-bit quantization computed by the correlator corresponds to a plurality of points uniformly spread around a unit circle or non-unit circle.

15. The receiver of claim 11 wherein the correlator comprises logic that compares a real part and an imaginary part of each point of the digitized signal and the known sequence.

16. The receiver of claim 15 wherein the logic quantizes phase information for each point of the first and second signals based on the comparison.

17. The electronic device of claim 11 wherein the correlator comprises a look-up table (LUT) that relates each of a plurality of multi-bit values to a point around a unit circle.

18. The receiver of claim 11 wherein the correlator comprises a look-up table (LUT) that relates each of a plurality of multi-bit values to an exponential of a point around a unit circle.

19. The electronic device of claim 11 wherein the correlator comprises logic that approximates an exponential operation for each of a plurality of quantized phases.

20. A method, comprising:
providing a multi-bit quantization of phase information for a first signal and a second signal; and
correlating the first and second signals based on the quantized phase information.

21. The method of claim 20 further comprising:
determining a quadrant for each point of the first and second signals;
comparing a real part and an imaginary part for each point of the first and second signals; and
quantizing phase information for each point of the first and second signals based on the comparison.

22. The method of claim 20 wherein correlating the first and second signals comprises accessing a look-up table (LUT) that relates each of a plurality of multi-bit values to a predetermined value.

23. The method of claim 20 wherein correlating the first and second signals comprises estimating an exponential operation involving the quantized phase information.
